(19) United States
(12) Patent Application Publication
(10) Pub. No.: US 2024/0111077 A1
(43) Pub. Date: Apr. 4, 2024

(54) OPTICAL ELEMENT, OPTICAL APPARATUS, AND IMAGE PICKUP APPARATUS

(71) Applicant: CANON KABUSHIKI KAISHA, Tokyo (JP)

(72) Inventors: HIDEO UKUDA, Kanagawa (JP); KEI TAGAMI, Kanagawa (JP)

(21) Appl. No.: 18/466,583

(22) Filed: Sep. 13, 2023

(30) Foreign Application Priority Data
Sep. 16, 2022 (JP) 2022-148287
May 24, 2023 (JP) 2023-085514

(51) Int. Cl. G02B 1/04; C08L 33/10; H04N 23/55

(52) U.S. Cl. CPC G02B 1/041; C08L 33/10; H04N 23/55

(57) ABSTRACT

An optical element includes a transparent base and a cured product disposed on the transparent base. The cured product contains a (meth)acrylate compound having an alicyclic skeleton. The amount of (meth)acrylate compound contained in the cured product is 70% or more by mass and 99.5% or less by mass.

### BACKGROUND

### Field of the Disclosure

The present disclosure relates to an optical element, an optical apparatus, and an image pickup apparatus.

### Description of the Related Art

One of the optical elements known is a lens including a cured resin composition disposed on a transparent base of, for example, glass. Such a lens is manufactured by placing a resin composition between a base and a mold and polymerizing or copolymerizing the resin composition to form a cured product having a predetermined shape on a surface of the base. Lenses manufactured by such a manufacturing method are called replica elements. Replica elements are effective for use as aspherical lenses and Fresnel lenses because desired surface shapes can be easily formed. The term “aspherical lens” is a general term for a lens whose curvature changes continuously from the lens center to the periphery. Japanese Patent Laid-Open Nos. 6-298886 and 8-157546 disclose resin compositions that can be used for replica elements.

However, the cured products of the resin compositions disclosed in Japanese Patent Laid-Open Nos. 6-298886 and 8-157546 have a high coefficient of hygroscopic expansion, and thus, for example, their optical performance is disadvantageously prone to change in high-humidity environments. In addition, a material having a low coefficient of hygroscopic expansion disadvantageously has insufficient adhesion to a transparent base.

### SUMMARY

One aspect of the present disclosure is directed to providing an optical element that includes a transparent base and a cured product disposed on the transparent base, the cured product containing a monofunctional (meth)acrylate compound and/or a difunctional (meth)acrylate compound having an alicyclic skeleton represented by any of the following general formulae (1) to (4), in which the amount of the (meth)acrylate compound contained in the cured product is 70% or more by mass and 99.5% or less by mass,

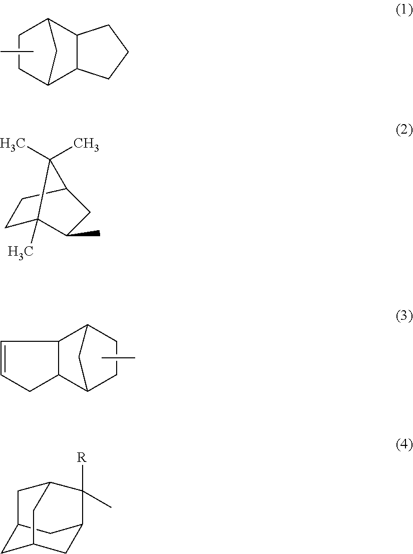

where in the general formula (4), R is a hydrogen atom, an alkyl group, or a substituted or unsubstituted alkylene group.

Further features of the present disclosure will become apparent from the following description of exemplary embodiments with reference to the attached drawings.

### BRIEF DESCRIPTION OF THE DRAWINGS

FIG. 1 is a schematic view of an optical element according to an embodiment of the present disclosure.

FIGS. 2A and 2B are schematic views illustrating a method for manufacturing an optical element according to an embodiment of the present disclosure.

FIG. 3 is a schematic view of an image pickup apparatus according to an embodiment of the present disclosure.

FIG. 4 is a schematic view illustrating the thickness of a cured product in an optical element in an example.

### DESCRIPTION OF THE EMBODIMENTS

Embodiments of the present disclosure will be described below.

### Optical Element

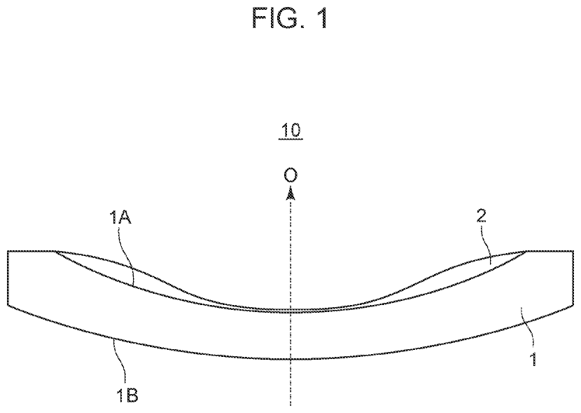

FIG. 1 is a schematic view illustrating an optical element according to a first embodiment, and is a side sectional view of an optical element 10 taken along a straight line passing through the element center O of the optical element in the lamination direction.

The optical element 10 has a transparent base 1 and a cured product 2. The optical element 10 is a type of optical element called a replica lens in which a cured product is disposed on the transparent base 1.

### Transparent Base

The transparent base 1 has a first surface 1A and a second surface 1B, which are optical surfaces. The first surface 1A of the transparent base is one of a light entrance surface and a light exit surface, and the second surface 1B of the transparent base is the other of the light entrance surface and the light exit surface.

The transparent base 1 can be composed of a transparent resin or transparent glass. In this specification, the term “transparent” indicates that light transmittance at a wavelength of 400 nm or more and 780 nm or less is 10% or more. The transparent base 1 can be composed of glass. Examples of the glass that can be used include common optical glasses, such as silicate glasses, borosilicate glasses, and phosphate glasses, quartz glass, and glass ceramics.

In FIG. 1, the first surface 1A has a concave spherical shape, and the second surface 1B has a convex spherical shape, but the transparent base 1 is not limited to a particular shape. The shape of the surface of the transparent base 1 in contact with the cured product 2 can be selected from, for example, a concave spherical shape, a convex spherical shape, an axisymmetric aspherical shape, and a planar shape in accordance with the desired properties. The transparent base 1 can have a circular shape when viewed from above the paper surface of FIG. 1. This is because when the optical element 10 is used as a lens in an optical system described below, the assembly accuracy is improved.

### Cured Product

The cured product 2 adheres to the first surface 1A of the transparent base. The cured product 2 is a cured product of a resin composition obtained by polymerizing or copolymerizing a resin composition 2a.

The resin composition 2a contains a first material, a second material, and a polymerization initiator. The first material is a polymer obtained by polymerizing a material containing at least one first monomer of a monofunctional (meth)acrylate having an alicyclic skeleton represented by any of the following general formulae (1) to (4):

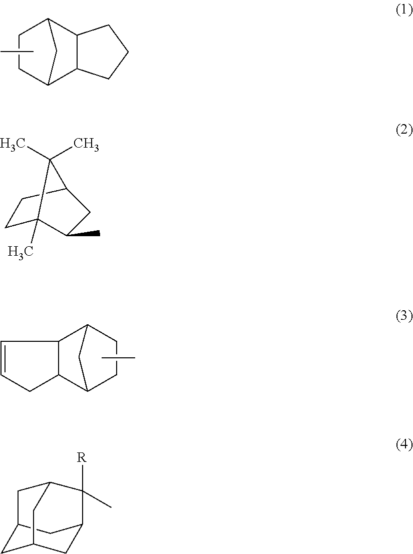

where in the general formula (4), R is a hydrogen atom, an alkyl group, or a substituted or unsubstituted alkylene group.

The alicyclic skeleton represented by the general formula (1) is a tricyclodecane skeleton. The alicyclic skeleton represented by the general formula (2) is an isobornyl skeleton. The alicyclic skeleton represented by the general formula (3) is a dicyclopentenyl skeleton. The alicyclic skeleton represented by the general formula (4) is an adamantane skeleton. Polymers each having the tricyclodecane skeleton, the isobornyl skeleton, the dicyclopentenyl skeleton, or the adamantane skeleton, which is represented by any of the general formulae (1) to (4), have low coefficients of hygroscopic expansion.

The second material is a second monomer containing a polymerizable functional group of a monofunctional (meth)acrylate having an alicyclic skeleton represented by any of the general formulae (1) to (4) and/or a third monomer containing a polymerizable functional group of a difunctional (meth)acrylate having an alicyclic skeleton represented by any of the general formulae (1) to (4).

In the resin composition 2a according to an embodiment of the present disclosure, the total amount of the first material and the second material contained is 70% or more by mass and 99.5% or less by mass. When the resin composition 2a according to an embodiment of the present disclosure having the composition ratio described above is cured into a cured product, the resulting cured product has a low coefficient of hygroscopic expansion and excellent adhesion to the transparent base. When the total amount contained is more than 99.5% by mass, the polymerization initiator content is relatively low. This may make curing more difficult, thereby leading to insufficient transfer accuracy of the cured product 2. At less than 70% by mass, the resulting cured product has a high coefficient of hygroscopic expansion; thus, the optical performance is prone to change in a high-humidity environment, such as a humidity of 80% or higher.

The cured product 2 obtained by polymerizing or copolymerizing the resin composition 2a contains a monofunctional (meth)acrylate compound and/or a difunctional (meth)acrylate compound. The total amount of the monofunctional (meth)acrylate compound and/or the difunctional (meth)acrylate compound contained in the cured product 2 is 70% or more by mass and 99.5% or less by mass. The optical element 10 according to an embodiment of the present disclosure has a low coefficient of hygroscopic expansion and excellent adhesion between the cured product 2 and the transparent base 1 because the cured product 2 has the above composition. When the total amount of the monofunctional (meth)acrylate compound and/or the difunctional (meth)acrylate compound contained is more than 99.5% by mass, the transfer accuracy of the cured product 2 may be insufficient. At less than 70% by mass, the resulting cured product has a high coefficient of hygroscopic expansion; thus, the optical performance is prone to change in a high-humidity environment, such as a humidity of 80% or higher.

The polymer, serving as the first material, that is obtained by polymerizing the material containing the at least one first monomer of the monofunctional (meth)acrylate having the alicyclic skeleton represented by any of the general formulae (1) to (4), plays a role in reducing the amount of cure shrinkage when the resin composition 2a is cured into the cured product 2. Thus, the first material improves the formation of the cured product. The resin composition 2a containing the combination of the first material and the second material has better adhesion to the transparent base 1 than the resin composition containing only the second material. The inventors of the present application consider the mechanism of excellent adhesion as follows: In the resin composition 2a, the second material, which is a monomer, is considered to be easily compatible with the alicyclic skeleton of the first material, which is a polymer. It is thus considered that the inside of the resin composition 2a containing the polymer having a high proportion of the alicyclic skeleton is hydrophobic and that the hydrophilic acrylate groups and methacrylate groups are present on the outside. We believe that when the resin composition 2a is disposed on the transparent base 1, the highly hydrophilic portions are located at the interface portion with the transparent base composed of, for example, glass, to improve the interaction at the interface between the transparent base and the resin composition, and the reaction efficiency with a coupling agent. It is thought that if the first material is not contained, the hydrophobic portions of the second material gather at the interface between the transparent base and the resin composition, leading to insufficient adhesion. The alicyclic skeletons contained in the first material and the second material are effective in increasing the Abbe number of the cured product 2. The bulky structure of the alicyclic skeleton is effective in increasing the glass transition temperature Tg of the resin composition 2a and the cured product 2. The first material, which is a polymer, is speculated to have a rigid structure due to its bulky structure. Thus, the cured product 2 has better brittleness and smaller birefringence than the cured product of the resin composition composed only of the second material.

The weight-average molecular weight of the polymer that is the first material can be in the range of 35,000 or more and 300,000 or less. When the weight-average molecular weight is within this range, the cured product 2 has excellent adhesion to the transparent base 1. A weight-average molecular weight of less than 35,000 may result in insufficient adhesion.

A weight-average molecular weight of more than 300,000 may lead to insufficient compatibility between the second monomer and the third monomer. Here, the weight-average molecular weight is a value in terms of poly(methyl methacrylate), and can be measured by gel permeation chromatography (GPC), for example. More specifically, monodisperse poly(methyl methacrylate) resins having known weight-average molecular weights and being available as reagents, and an analytical gel column that first elutes high-molecular-weight components are used to prepare a calibration curve from the elution times and the weight-average molecular weights. The weight-average molecular weight (Mw) can then be determined on the basis of the resulting calibration curve.

The proportion of the polymer serving as the first material contained in the resin composition 2a can be 5% or more by mass and 30% or less by mass. That is, the proportion of the polymer serving as the first material contained in the cured product 2 can be 5% or more by mass and 30% or less by mass. When the proportion of the polymer contained is within this range, the resulting cured product is more likely to have both good adhesion to the transparent base and a low coefficient of hygroscopic expansion.

Regarding the polymer serving as the first material, the proportion of a portion of the polymer in which the first monomer of a monofunctional (meth)acrylate having an alicyclic skeleton represented by any of the general formulae (1) to (4) has been polymerized can be 60% or more by mass and 100% or less by mass. That is, the polymer serving as the first material may be obtained by polymerizing a (meth)acrylate monomer having no alicyclic skeleton. However, the portion in which the (meth)acrylate monomer having no alicyclic skeleton has been polymerized can be less than 40% by mass. When the above-described range is satisfied, the alicyclic skeleton portion in the cured product 2 can be in a sufficient amount to further reduce the coefficient of hygroscopic expansion.

Examples of a commercially available compound serving as the first monomer include FA-513M (dicyclopentanyl methacrylate) and FA-512M (dicyclopentenyloxyethyl methacrylate) of Fancryl series available from Showa Denko Materials Co., Ltd., IB (isobornyl methacrylate) and A-IB (isobornyl acrylate), both are available from Shin-Nakamura Chemical Co., Ltd., and IB-X (isobornyl methacrylate) and IB-AX (isobornyl acrylate), both are available from Kyoeisha Chemical Co., Ltd. As reagents, compounds having a plurality of adamantane skeletons, such as adamantan-1-yl acrylate and 2-isopropyl-2-methacryloyloxyadamantane available from Tokyo Chemical Industry Co., Ltd., can be used. The first monomer may be used alone, or two or more types thereof may be used in combination in accordance with the viscosity during the formation of the cured product 2, the cure shrinkage ratio, the coefficient of hygroscopic expansion, the optical properties, and other properties.

The second material is the second monomer and/or the third monomer. A network structure is formed by polymerizing the polymerizable functional groups of the second monomer and the third monomer. Each of the second and third monomers has an alicyclic skeleton and thus is incorporated into the alicyclic skeleton of the polymer serving as the first material while the network structure is formed during the polymerization reaction. The cured product 2, therefore, has excellent adhesion to the transparent base 1. The bulky structure of the alicyclic skeleton is effective in increasing the glass transition temperature Tg of the resin composition 2a and the cured product 2, compared with a resin composition containing a monomer having no alicyclic skeleton and the cured product thereof. The amount of curing shrinkage is reduced because of its bulky structure, thereby improving the formability.

The second material can be a mixture containing the second monomer and the third monomer. The total amount of the second monomer and the third monomer contained in the resin composition 2a can be 40% or more by mass and 93% or less by mass. This is because the resulting cured product is more likely to have both good adhesion to the transparent base and a low coefficient of hygroscopic expansion.

The proportion of the difunctional (meth)acrylate compound contained in the cured product 2 can be 28% or more by mass and 79% or less by mass. This is because the resulting cured product is more likely to have both good adhesion to the transparent base and a low coefficient of hygroscopic expansion.

Examples of a commercially available compound serving as the second monomer include FA-513M (dicyclopentanyl methacrylate) and FA-512M (dicyclopentenyloxyethyl methacrylate) of Fancryl series available from Showa Denko Materials Co., Ltd., IB (isobornyl methacrylate) and A-LB (isobornyl acrylate), both are available from Shin-Nakamura Chemical Co., Ltd., and IB-X (isobornyl methacrylate) and IB-AX (isobornyl acrylate), both are available from Kyoeisha Chemical Co., Ltd. As reagents, compounds having a plurality of adamantane skeletons, such as adamantan-1-yl acrylate and 2-isopropyl-2-methacryloyloxyadamantane available from Tokyo Chemical Industry Co., Ltd., can be used. Only one type of the second monomer may be used, or two or more types thereof may be used in combination in accordance with the viscosity during the formation of the cured product 2, the cure shrinkage ratio, the coefficient of hygroscopic expansion, the optical properties, and other properties.

Examples of a commercially available compound serving as the third monomer include DCP (dimethylol tricyclodecane dimethacrylate) and A-DCP (dimethylol tricyclodecane diacrylate), both are available from Shin-Nakamura Chemical Co., Ltd., and DCP-M (dimethylol tricyclodecane dimethacrylate) and DCP-A (dimethylol tricyclodecane diacrylate), both are available from Kyoeisha Chemical Co., Ltd. Only one type of the third monomer may be used, or two or more types thereof may be used in combination in accordance with the viscosity during the formation of the cured product 2, the cure shrinkage ratio, the coefficient of hygroscopic expansion, the optical properties, and other properties.

The resin composition 2a can contain a sulfur-containing compound having at least one thiol group. The sulfur-containing compound plays a role in improving toughness. Thus, the sulfur-containing compound improves the impact resistance of the cured product. The use of the resin composition 2a having the combination of the first material, the second material, and the sulfur-containing compound results in excellent toughness, compared with the resin composition composed of the first material and the second material.

The inventors of the present application consider the mechanism by which the incorporation of the sulfur-containing compound into the resin composition results in excellent toughness as described below.

The use of the first material results in excellent toughness, compared with the resin composition consisting only of the second material. The inventors believe that the incorporation of the sulfur-containing compound can impart flexibility to the network structure formed by the polymerization reaction of the polymerizable functional groups of the second monomer and the third monomer. The inventors consider that the incorporation of a network structure with flexibility into the polymer serving as the first material will further improve toughness due to the synergistic effect of the toughness-improving effect of the first material and the flexible network structure. The use of the sulfur-containing compound can impart flexibility and thus can result in better adhesion to the transparent base 1 and a smaller amount of cure shrinkage to improve the formability.

The amount of the sulfur-containing compound having at least one thiol group contained in the cured product 2 is 1% or more by mass and 15% or less by mass. This is because within the above range, the cured product is excellent in toughness and satisfies good adhesion to the transparent base and a low coefficient of hygroscopic expansion. The amount of the sulfur-containing compound having at least one thiol group contained in the cured product 2 is more preferably 2% or more by mass and 10% or less by mass, still more preferably 2% or more by mass and 6% or less by mass. The sulfur-containing compound can have two or more thiol groups in its molecule from the viewpoint of achieving good toughness. From the viewpoint of reducing the coefficient of hygroscopic expansion, the sulfur-containing compound can have two thiol groups in its molecules.

Only one type of sulfur-containing compound having at least one thiol group in its molecule may be used. Two or more types thereof, however, may be used in combination in accordance with the viscosity during the formation of the cured product, the cure shrinkage ratio, the coefficient of hygroscopic expansion, the optical properties, and other properties. Examples of a commercially available compound serving as the sulfur-containing compound include 1-dodecanethiol, tert-tetradecanethiol, bis(2-mercaptoethyl) sulfide, 1,4-butanediol bis(thioglycolate), 1,4-bis(3-mercaptobutyroyloxy) butane, trimethylolpropane tris(3-mercaptopropionate), pentaerythritol tetra(3-mercaptopropionate), and pentaerythritol tetrakis(3-mercaptobutylate).

The resin composition 2a contains a polymerization initiator. The polymerization initiator may be a photoinitiator or a thermal polymerization initiator, which can be determined in accordance with a manufacturing process selected. In the case of replica molding for forming an aspherical shape, a photoinitiator can be used from the viewpoint of its high curing rate. Examples of a commercially available photoinitiator include 2-benzyl-2-(dimethylamino)-1-[4-(morpholino)phenyl]-1-butanone, 1-hydroxycyclohexyl phenyl ketone, bis(2,4,6-trimethylbenzoyl)phenylphosphine oxide, 4-phenylbenzophenone, 4-phenoxybenzophenone, 4,4′-diphenylbenzophenone, and 4,4′-diphenoxybenzophenone. The resin composition 2a can have a photoinitiator content of 0.01% or more by mass and 10% or less by mass. A photoinitiator content of less than 0.01% by mass may result in insufficient reactivity. A photoinitiator content of more than 10% by mass may result in a decrease in the transmittance of the cured product 2. An unreacted polymerization initiator remains in the cured product 2.

If necessary, a polymerization inhibitor, an antioxidant, a light stabilizer (hindered amine light stabilizer, HALS), an ultraviolet absorber, a silane coupling agent, a release agent, a pigment, a dye, and other additives may be added to the resin composition 2a.

The cured product 2 can have high transparency. Specifically, the internal transmittance at a wavelength of 400 nm and a converted thickness of 500 μm can be 70% or more. The cured product 2 can have an Abbe number of 50 or more and less than 60. Within these ranges, various optical designs can be used when the optical element 10 is used as a lens in an optical system.

The cured product 2 can have small birefringence, specifically within 0.0003. The birefringence of the cured product 2 is the difference between a refractive index n_{d}^{s} for S-polarized light (in-plane direction of the plane of incidence) and a refractive index nₛ^{p} for P-polarized light (thickness direction) of the d-line (587.6 nm).

In FIG. 1, the cured product 2 has a non-uniform thickness within the plane of the first surface 1A. That is, the shape of the surface of the cured product 2 that is not in contact with the transparent base 1 is aspherical. In the present embodiment, the cured product has a thickness distribution with the minimum thickness d1 at about the center O of the element and the maximum thickness d2 at the peripheral portion of the element. However, this shape is not necessarily required. For example, the thickness distribution may have the maximum thickness d2 at about the center O of the element and the minimum thickness d1 at the peripheral portion of the element. The proportion of the maximum thickness d2 to the minimum thickness d1 of the cured product 2 is preferably more than 1 and 30 or less. At a proportion of more than 30, the large difference in the thickness of the cured product 2 may result in a failure to maintain a high surface accuracy during cure shrinkage. More preferably, the proportion is 8 or more. The minimum thickness d1 can be 300 μm or less, and the maximum thickness d2 can be 10 μm or more and 1,000 μm or less.

The coefficient of hygroscopic expansion of the cured product 2 disposed on the transparent base 1 is preferably less than 0.30%. This is because a change in optical properties due to hygroscopic expansion can be reduced. A coefficient of hygroscopic expansion of 0.30% or more results in a significant change in the surface shape of the cured product 2 before and after water absorption. This may cause a change in image quality when the cured product 2 is used in an optical system. The coefficient of hygroscopic expansion is more preferably 0.23% or less.

The coefficient of hygroscopic expansion is still more preferably 0.19% or less. The coefficient of hygroscopic expansion can be evaluated by placing the optical element 10 in a thermo-hygrostat at a temperature of 40° C. and a humidity of 90% for 16 hours, taking out the optical element 10 in a room-temperature environment (23° C.±2° C.), and after 20 minutes, evaluating the surface shape of the cured product 2 with a surface profiler.

In the present embodiment, the optical element 10 includes the transparent base 1. However, the transparent base 1 need not be included, depending on the optical properties of the optical element 10.

### Method for Manufacturing Optical Element

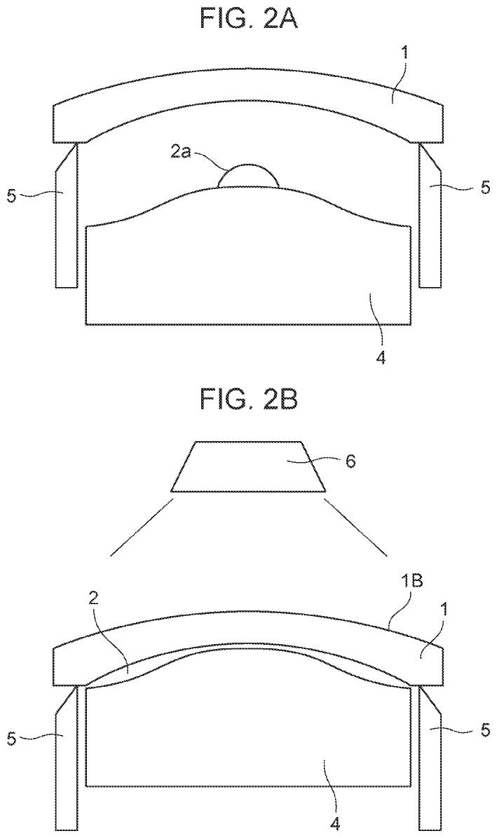

A method for manufacturing an optical element according to the first embodiment is not particularly limited. An example of the manufacturing method will be described below. FIGS. 2A and 2B are schematic views illustrating a method for manufacturing an optical element according to the first embodiment.

The transparent base 1 and the resin composition 2a are provided (provision step). To improve the adhesion between the transparent base 1 and the cured product 2, the first surface 1A of the transparent base can be subjected to pretreatment. When the transparent base 1 is composed of glass, for example, silane coupling treatment, corona discharge treatment, UV-ozone treatment, and plasma treatment can be selected. From the view point of forming direct chemical bonds of the cured product 2 with the first surface 1A to further improve the adhesion, coupling treatment with a silane coupling agent can be performed. Specific examples of the coupling agent include 3-methacryloxypropylmethyldimethoxysilane, 3-methacryloxypropyltrimethoxysilane, 8-methacryloxyoctyltrimethoxysilane, 3-acryloxypropyltrimethoxysilane, 3-methacryloxypropylmethyldiethoxysilane, and 3-methacryloxypropyltriethoxysilane.

A method for preparing the resin composition 2a is not particularly limited. For example, first, a material containing at least one first monomer is polymerized to provide a polymer. Here, the material may contain a monomer having no alicyclic skeleton other than the first monomer. Conditions for obtaining a polymer are not limited to particular conditions. The heating temperature can be 80° C. or lower because the molecular weight of the polymer may decrease if the polymerization temperature is increased. The lower limit of the temperature is not limited to a particular value, but the lower limit can be 50° C. or higher from the viewpoint of not making the process time too long. Then the polymer, the second monomer, the third monomer, and the polymerization initiator can be mixed to prepare the resin composition 2a. The mixing method and time are not particularly limited. These components can be mixed so as to give a uniform mixture.

As illustrated in FIG. 2A, the resin composition 2a is dropped onto a mold 4. The resin composition 2a is an ultraviolet curable composition containing a photoinitiator. The transparent base 1 is placed on an ejector 5 and disposed at a position facing the mold 4. The mold 4 is, for example, a mold that has an inverted shape of a desired aspherical shape on a surface and can be manufactured by cutting a metal base of, for example, a stainless steel material or a steel material, plated with NiP or oxygen-free copper by a precision processing machine. The surface of the mold 4 may be coated with a release agent to control the releasability of the resin. The type of mold release agent is not particularly limited. An example thereof is a fluorine-containing coating agent.

Subsequently, as illustrated in FIG. 2B, the ejector 5 is lowered to bring the mold 4 closer to the transparent base 1, thereby providing the resin composition 2a on the transparent base 1 (installation step). The ejector 5 is further lowered to fill the gap between the mold 4 and the transparent base 1 with the uncured resin composition 2a to form a desired shape (molding step).

Ultraviolet irradiation is performed from the second surface 1B side of the transparent base 1 using an ultraviolet light source 6 to provide the cured product 2 that is a polymerized and cured product of the resin composition 2a (curing step, light irradiation step).

Thereafter, the cured product 2 obtained by polymerization and curing is released from the mold 4 to provide the optical element 10 including the cured product 2 having an aspherical shape on the transparent base 1. After the cured product 2 is formed, additional ultraviolet irradiation or heat treatment may be performed in air or in an oxygen-free atmosphere.

The optical element according to an embodiment of the present disclosure can be manufactured by the manufacturing method described above. In the installation step, the resin composition 2a may be dropped onto both the mold 4 and the transparent base 1, or may be dropped onto the transparent base 1 only. When the resin composition 2a contains a thermal polymerization initiator as a curing initiator, the light irradiation step may be changed to a heat treatment step. After the curing step, the transparent base 1 may be separated from the optical element 10 and only the cured product 2 may be used as the optical element 10.

### Optical Apparatus

Specific application examples of the optical element of the above-described embodiment include lenses included in optical apparatus (photographic optical systems) for cameras and camcorders, and lenses included in optical apparatus (projection optical systems) for liquid crystal projectors. Moreover, the optical element can be used for a pickup lens of a DVD recorder or the like. These optical systems each include at least one lens disposed in a housing, and the above-described optical element can be used for the at least one lens.

### Image Pickup Apparatus

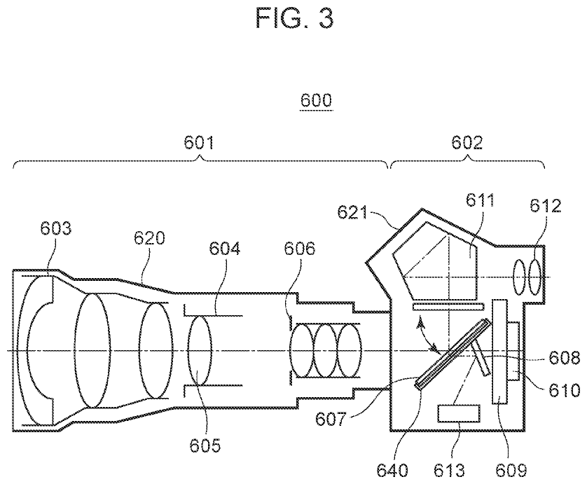

FIG. 3 is a schematic view illustrating the configuration of a digital single-lens reflex camera 600 as an example of an embodiment of an image pickup apparatus including the optical element according to the above-described embodiment. In FIG. 3, a camera body 602 and a lens barrel 601, which is an optical apparatus, are connected to each other. The lens barrel 601 is what is called an interchangeable lens that can be attached to and detached from the camera body 602.

Light from a subject is captured through an optical system including, for example, a plurality of lenses 603 and 605 arranged on the optical axis of the photographic optical system in a housing 620 of the lens barrel 601. The above optical element can be used for each of the lenses 603 and 605, for example. Here, the lens 605 is supported by the inner cylinder 604, and is movably supported with respect to the outer cylinder of the lens barrel 601 for focusing and zooming.

For the duration of observation before capturing, light from a subject is reflected by a main mirror 607 in the housing 621 of the camera main body and passes through a prism 611. Then, a photographer sees the capturing image through a viewfinder lens 612. The main mirror 607 is, for example, a semi-transparent mirror. The light that has passed through the main mirror is reflected by a sub-mirror 608 toward an autofocusing (AF) unit 613. This reflected light is used for, for example, focusing. The main mirror 607 is mounted on and supported by a main mirror holder 640 using adhesion or the like. During capturing, the main mirror 607 and the sub-mirror 608 are moved to positions outside the optical path using a driving mechanism (not illustrated), a shutter 609 is opened, an image pickup element 610 receives light that has been incident from the lens barrel 601 and passed through the photographic optical system, and a photographic light image is focused thereon. A diaphragm 606 is configured in such a manner that the brightness and the focal depth during capturing can be changed by adjusting the aperture area.

Although the image pickup apparatus has been described here using the digital single-lens reflex camera, the image pickup apparatus can also be used in the same way for smartphones, compact digital cameras, drones, and so forth.

### EXAMPLES

Examples and comparative examples will be described below. First, evaluation methods in examples and comparative examples will be described.

### Water Absorption Test

The coefficients of hygroscopic expansion of cured products serving as optical elements in examples and comparative examples were each evaluated with an optical element including a cured product disposed on a transparent base.

The resulting optical element was placed in a thermo-hygrostat at a temperature of 40° C. and a humidity of 90% for 16 hours.

Subsequently, the optical element was taken out in a room-temperature environment (23° C.±2° C.), and after 20 minutes, the surface shape of the cured product was evaluated with a surface profiler (Form Talysurf Laser, available from TAYLOR HOBSON). The measurement was performed by linearly scanning light from an end portion of the optical element to the opposite end portion through the center portion at a scanning rate of 0.5 mm/s. The coefficient of hygroscopic expansion [%] of the optical element was calculated from the following formula using the average thickness D0 before water absorption and the average thickness D1 after water absorption.

Coefficient of hygroscopic expansion [%]=((D1−D0)/D0)×100

The optical element was rated A when there was no peeling of the cured product and the coefficient of hygroscopic expansion was less than 0.20%, and B when there was no peeling of the cured product and the coefficient of hygroscopic expansion was less than 0.30%. The optical element was rated C when the cured product was peeled off or the coefficient of hygroscopic expansion was 0.30% or more. The optical elements rated A or B were regarded as acceptable elements.

### Adhesion Test

An acid was added to a mixture of 90% by mass of ethyl alcohol and 10% by mass of water to prepare a mixed solution with an adjusted pH of 3 to 4. Then 3% by mass of 3-methacryloxypropyltrimethoxysilane was added to the mixed solution to prepare a resin-glass coupling solution. The surfaces of a glass substrate (BK7) having a size of 40 mm×50 mm and a thickness of 2.5 mm and a glass substrate (BK7) having a size of 50 mm×60 mm and a thickness of 1 mm were washed. The coupling solution was dropped onto the surface to be brought into contact with the resin, and dried. Thereafter, an excess of the coupling agent was wiped off with a cloth. The glass substrate was baked at 100° C. for 30 to 60 minutes and allowed to cool to room temperature.

A 500 μm-thick spacer and an uncured resin composition, which was a precursor for a cured product to be measured, were placed on the coupling-treated glass substrate having a size of 40 mm×50 mm and a thickness of 2.5 mm. The coupling-treated glass substrate having a size of 50 mm×60 mm and a thickness of 1 mm was placed on the substrate with the spacer interposed therebetween in such a manner that the centers of the glass substrates were aligned, to spread the uncured resin composition.

The spacer was removed. A high-pressure mercury lamp (UL750, available from Hoya Candeo Optronics Corp.) was used to irradiate the glass substrates with light at 20 mW/cm² (=illuminance through the glass substrate) for 2,500 seconds (50 J). The resin composition was cured and annealed at 80° C. for 16 hours. This was used as a sample for adhesion evaluation. The cured product had a thickness of 500 μm and a size of 40 mm×50 mm on the glass surface.

The glass substrate having a size of 40 mm×50 mm and a thickness of 2.5 mm was fixed. An ejector was pressed against the glass substrate, having a size of 50 mm×60 mm and a thickness of 1 mm, at positions 2 mm from ends of the long axis portion thereof. A load at the time of the occurrence of mold release was measured.

The cured product exhibiting a load of 250 N or more was rated A. The cured product exhibiting a load of 150 N or more and less than 250 N was rated B. The cured product exhibiting a load of less than 150 N was rated C. The cured products rated A or B were regarded as acceptable products.

### Toughness Test

The toughness of the cured product of the optical element of each of examples and comparative examples was evaluated by peeling the transparent base from the optical element and taking out the cured product. The cured product was processed into a strip shape measuring 5 mm×30 mm to prepare a test specimen. The thickness of the test specimen was 100 μm. The test specimen was measured with a dynamic viscoelasticity measuring machine (E-4000, available from UBM) at a test temperature of 23° C. and a tension speed of 1.0 mm/sec. The area of the stress-strain diagram was defined as breaking energy. The specimen exhibiting a breaking energy of 5.0 MJ/m³ or more was rated A. The specimen exhibiting a breaking energy of 1.0 MJ/m³ or more and less than 5.0 MJ/m³ was rated B. The specimen exhibiting a breaking energy of less than 1.0 MJ/m³ was rated C. The cured products rated A or B were regarded as acceptable products.

D-Line Refractive index nd, Abbe number νd, and Birefringence

The refractive index nd, the Abbe number νd, and the birefringence of the cured products of the optical elements of examples and comparative examples were evaluated by preparing samples for the evaluation of the optical properties. It is also possible to peel off the transparent base from the optical element and take out the cured product for evaluation without using a sample for the evaluation of the optical properties. First, a method for preparing a sample for the evaluation of the optical properties will be described.

A spacer having a thickness of 500 μm and an uncured resin composition, as a precursor for a cured product to be measured, were placed on a glass sheet (S-TIH, available from Ohara Inc.) having a thickness of 1 mm. A quartz glass sheet having a thickness of 1 mm was placed thereon with the spacer interposed therebetween to spread the uncured resin composition. The spacer was removed. A high-pressure mercury lamp (UL750, available from Hoya Candeo Optronics Corp.) was used to irradiate the quartz glass sheet with light at 20 mW/cm² (=illuminance through the quartz glass sheet) for 2,500 seconds (50 J). The resin composition was cured. The quartz glass sheet was peeled off. The cured resin composition was annealed at 80° C. for 16 hours to provide a sample for the evaluation of the optical properties.

The cured product had a thickness of 500 μm and a size of 5 mm 20 mm on the glass surface.

The refractive indices nf nd, and nc of the resulting samples for P-polarized light (thickness direction) and S-polarized light (in-plane direction) of the f-line (486.1 nm), the d-line (587.6 nm), and the c-line (656.3 nm) were measured from the glass side using a refractometer (KPR-30, available from Shimadzu Corporation).

The birefringence was defined as the difference between the refractive index n_{d}^{s} for S-polarized light (in-plane direction) and the refractive index n_{d}^{p} for P-polarized light (thickness direction) of the d-line (587.6 nm).

Δnd=n_{d}^{s}−n_{d}^{p}

The Abbe number was calculated from the measured refractive indices. The Abbe number νd was calculated from the following formula.

Abbe number νd=(nd−1)/(nf−nc)

### Evaluation of Internal Transmittance

The internal transmittance of the cured product of the optical element of each of examples and comparative examples was evaluated by preparing a sample for the evaluation of optical properties. It is also possible to peel off the transparent base from the optical element and take out the cured product for evaluation without using a sample for the evaluation of the optical property. First, a method for preparing a sample for the evaluation of the optical property will be described.

A spacer having a thickness of 500 μm and an uncured resin composition, as a precursor for a cured product to be measured, were placed on a glass sheet (BSL7, available from Ohara Inc.) having a thickness of 1 mm. A quartz glass sheet having a thickness of 1 mm was placed thereon with the spacer interposed therebetween to spread the uncured resin composition. The spacer was removed. A high-pressure mercury lamp (UL750, available from Hoya Candeo Optronics Corp.) was used to irradiate the quartz glass sheet with light at 20 mW/cm² (=illuminance through the quartz glass sheet) for 2,500 seconds (50 J). The resin composition was cured. The quartz glass sheet was peeled off. The cured resin composition was annealed at 80° C. for 32 hours to prepare a sample for the evaluation of the optical property. The cured product had a thickness of 500 μm and a size of 5 mm×20 mm on the glass surface.

The transmittance of the resulting sample in the visible region (λ: 400 to 700 nm) was measured using a spectrophotometer (UH4150, available from Hitachi High-Tech Science Corporation). The internal transmittance was calculated from the refractive indices of the glass sheet and the resin.

### Minimum Thickness d1 and Maximum Thickness d2

The minimum thickness d1 and the maximum thickness d2 of the cured product of the optical element of each of examples and comparative examples were evaluated using an optical element in which a cured product was disposed on a transparent base.

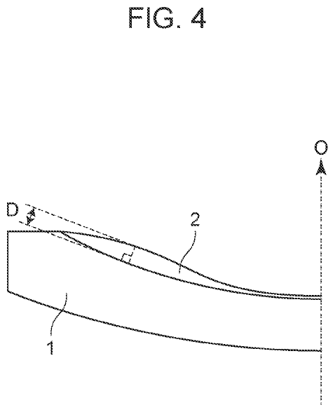

The resulting optical element was placed in a constant-temperature oven at 80° C. for 16 hours. Subsequently, the optical element was taken out in a room-temperature environment (23° C.±2° C.), and after 20 minutes, the surface shape of the cured product was evaluated with a surface profiler (Form Talysurf Laser, available from TAYLOR HOBSON). The measurement was performed by linearly scanning light from an end portion of the optical element to the opposite end portion through the center portion at a scanning rate of 0.5 mm/s. The vertical distance from the interface between the transparent base 1 and the cured product 2 to the measured surface shape of the cured product 2 was calculated to determine the thickness D of the cured product 2. FIG. 4 illustrates the thickness D. The average value of the thicknesses obtained in the radial direction was denoted as D0, the minimum thickness was denoted as d1, and the maximum thickness was denoted as d2.

### Manufacture of Optical Element

### Example 1

A resin composition 2a was first prepared. Dicyclopentanyl methacrylate (A-1: monofunctional, FA-513M, available from Showa Denko Materials Co., Ltd.) was provided as a first monomer of a monofunctional (meth)acrylate having an alicyclic skeleton. After 100 parts by mass of the dicyclopentanyl methacrylate and 100 parts by mass of toluene were mixed, 1 part by mass of 2,2′-azobis(isobutyronitrile (AIBN, available from Tokyo Chemical Industry Co., Ltd.) was added thereto. The mixture was heated at 60° C. for 6 hours while bubbling with nitrogen gas. Then the mixture was purified by reprecipitation in 1,000 parts by mass of methanol. Filtration and vacuum drying were performed to give a polymer as a first material. The weight-average molecular weight (Mw) of the polymer was 173,000 in terms of poly(methyl methacrylate).

Dicyclopentanyl methacrylate (B-1: monofunctional, FA-513M, available from Showa Denko Materials Co., Ltd.) was provided as a second monomer containing a polymerizable functional group of a monofunctional (meth)acrylate having an alicyclic skeleton. Dimethylol tricyclodecane dimethacrylate (B4: difunctional, DCP, available from Shin-Nakamura Chemical Co., Ltd.) was provided as a third monomer containing a polymerizable functional group of a difunctional (meth)acrylate having an alicyclic skeleton. In addition, 1-hydroxycyclohexyl phenyl ketone (D-1: photoinitiator, Omnirad 184, available from IGM Resins) was provided as a polymerization initiator. Into a vessel, 11.8 parts by mass of the polymer, 27.4 parts by mass of the second monomer B-1, 58.8 parts by mass of the third monomer B-4, and 2 parts by mass of the polymerization initiator D-1 were placed. They were uniformly mixed to prepare the resin composition 2a of Example 1. Table 1 summarizes the characteristics of the resin composition 2a of Example 1.

An optical element illustrated in FIG. 1 was manufactured by the manufacturing method illustrated in FIGS. 2A and 2B. As the transparent base 1, an optical glass base (S-TIM8, available from Ohara Inc.) with a diameter of 32 mm was provided. Regarding the shape, one surface (the first surface 1A) was a concave spherical shape with a radius of curvature of 40 mm, and the other surface (the second surface 1B) was a convex spherical shape with a radius of curvature of 75 mm. As the mold 4, a mold obtained by cutting a NiP layer plated on a metal base with a precision processing machine to form an inverted shape of the aspherical shape of the cured product 2 to be molded was used.

The resin composition 2a of Example 1 was filled into the gap between the transparent base 1 and the mold 4. To cure the resin composition 2a, the entire surface was irradiated with ultraviolet rays having a wavelength of 365 nm and an intensity of 10 mW/cm² for 200 seconds. After the mold 4 was released, heating was performed at 80° C. for 24 hours to form the cured product 2 on the first surface 1A of the transparent base 1, thereby providing the optical element 10 of Example 1.

The cured product of the optical element of Example 1 had a coefficient of hygroscopic expansion of 0.08%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 1 had a refractive index nd of 1.53 at the d-line and an Abbe number νd of 54. The birefringence was −0.00010, which was sufficiently small. The internal transmittance at a thickness of 500 μm and a wavelength of 400 nm was 97.6%, which was good.

The cured product of the optical element of Example 1 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 1.

### Example 2

Example 2 was different from Example 1 in the composition of the resin composition. Specifically, this example was different from Example 1 in that dimethylol tricyclodecane diacrylate (B-3: difunctional, A-DCP, available from Shin-Nakamura Chemical Co., Ltd.) was provided as the third monomer. In addition, the shape of the mold 4 was different from that of Example 1. The optical element of Example 2 was manufactured in the same manner as in Example 1, except for the above.

The cured product of the optical element of Example 2 had a coefficient of hygroscopic expansion of 0.12%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 2 had a refractive index nd of 1.53 at the d-line and an Abbe number νd of 54. The birefringence was −0.00008, which was sufficiently small. The internal transmittance at a thickness of 500 μm and a wavelength of 400 nm was 98.1%, which was good.

The cured product of the optical element of Example 2 had a shape with the minimum thickness at the central portion and the maximum thickness at the peripheral portion. The minimum thickness d1 was 30 μm, the maximum thickness d2 was 380 μm, and d2/d1 was 12.7. Table 2 summarizes the characteristics of the cured product 2 of Example 2.

### Example 3

Example 3 was different from Example 1 in the composition of the resin composition. The first material was prepared and purified under the same conditions as in Example 1, but was different from Example 1 in that the weight-average molecular weight of the polymer was 216,000. In addition, Example 3 was different from Example 1 in that dimethylol tricyclodecane diacrylate (B-3: difunctional, A-DCP, available from Shin-Nakamura Chemical Co., Ltd.), which was a third monomer, and 1,9-nonanediol dimethacrylate (C-2: difunctional, NOD-N, available from Shin-Nakamura Chemical Co., Ltd.), which was a monomer containing a polymerizable functional group of a (meth)acrylate having no alicyclic skeleton, were provided as the second material. Table 1 summarizes the characteristics of the resin composition 2a of Example 3. The optical element of Example 3 was manufactured in the same manner as in Example 1, except for the above.

The cured product of the optical element of Example 3 had a coefficient of hygroscopic expansion of 0.14%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 3 had a refractive index nd of 1.52 at the d-line and an Abbe number νd of 55. The birefringence was −0.00012, which was sufficiently small. The internal transmittance at a thickness of 500 μm and a wavelength of 400 nm was 97.7%, which was good.

The cured product of the optical element of Example 3 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 3.

### Example 4

Example 4 was different from Example 3 in the composition of the resin composition. This example was different from Example 3 in that trimethylolpropane trimethacrylate (C-3: trifunctional, TMPT, available from Shin-Nakamura Chemical Co., Ltd.) was provided as a monomer containing a polymerizable functional group of a (meth)acrylate having no alicyclic skeleton. The optical element of Example 4 was manufactured in the same manner as in Example 3, except for the above.

The cured product of the optical element of Example 4 had a coefficient of hygroscopic expansion of 0.17%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 4 had a refractive index nd of 1.52 at the d-line and an Abbe number νd of 54. The birefringence was −0.00009, which was sufficiently small. The internal transmittance at a thickness of 500 μm and a wavelength of 400 nm was 97.4%, which was good.

The cured product of the optical element of Example 4 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 4.

### Example 5

Example 5 was different from Example 4 in the composition ratio of the resin composition. This example was different from Example 4 in that 1,4-butanediol bis(thioglycolate) (E-1: difunctional, available from Tokyo Chemical Industry Co., Ltd.) was provided as a sulfur-containing compound having at least one thiol group. The optical element of Example 5 was manufactured in the same manner as in Example 4, except for the above.

The cured product of the optical element of Example 5 had a coefficient of hygroscopic expansion of 0.19%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 5.0 MJ/m³ or more. Thus, the optical element was rated A. The cured product 2 of Example 5 had a refractive index nd of 1.52 at the d-line and an Abbe number νd of 54. The birefringence was −0.00013, which was sufficiently small. The internal transmittance at a thickness of 500 μm and a wavelength of 400 nm was 98.5%, which was good.

The cured product of the optical element of Example 5 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 5.

### Example 6

Example 6 was different from Example 5 in the composition of the resin composition. This example was different from Example 5 in that trimethylolpropane tris(3-mercaptopropionate) (E-2: trifunctional, available from Tokyo Chemical Industry Co., Ltd.) was provided as the sulfur-containing compound having at least one thiol group. The optical element of Example 6 was manufactured in the same manner as in Example 5, except for the above.

The cured product of the optical element of Example 6 had a coefficient of hygroscopic expansion of 0.22%, and no peeling was observed. Thus, the optical element was rated B. In the adhesion test, the load was 250 N or more when mold release occurred, and peeling at the glass interface was not observed. Thus, the optical element was rated A. In the toughness test, the breaking energy was 5.0 MJ/m³ or more. Thus, the optical element was rated A. The cured product 2 of Example 6 had a refractive index nd of 1.52 at the d-line and an Abbe number νd of 55. The birefringence was −0.00013, which was sufficiently small. The internal transmittance at a thickness of 500 μm and a wavelength of 400 nm was 97.9%, which was good.

The cured product of the optical element of Example 6 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 6.

### Example 7

Example 7 was different from Example 6 in the composition of the resin composition. This example was different from Example 6 in that 1-dodecanethiol (E-3: monofunctional, available from Tokyo Chemical Industry Co., Ltd.) was provided as the sulfur-containing compound having at least one thiol group. The optical element of Example 7 was manufactured in the same manner as in Example 6, except for the above.

The cured product of the optical element of Example 7 had a coefficient of hygroscopic expansion of 0.18%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 7 had a refractive index nd of 1.52 at the d-line and an Abbe number νd of 55. The birefringence was −0.00010, which was sufficiently small. The internal transmittance at a thickness of 500 μm and a wavelength of 400 nm was 97.6%, which was good.

The cured product of the optical element of Example 7 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 7.

### Example 8

Example 8 was different from Example 2 in the composition ratio of the resin composition. Table 1 summarizes the characteristics of the resin composition 2a of Example 8. The optical element of Example 8 was manufactured in the same manner as in Example 2, except for the above.

The cured product of the optical element of Example 8 had a coefficient of hygroscopic expansion of 0.18%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 8 had a refractive index nd of 1.53 at the d-line and an Abbe number νd of 54. The birefringence was −0.00005, which was sufficiently small. The internal transmittance at a thickness of 500 μm and a wavelength of 400 nm was 97.8%, which was good.

The cured product of the optical element of Example 8 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 8.

### Example 9

Example 9 was different from Example 2 in the composition ratio of the resin composition. Table 1 summarizes the characteristics of the resin composition 2a of Example 9. The weight-average molecular weight of the polymer was 219,000. The optical element of Example 9 was manufactured in the same manner as in Example 2, except for the above.

The cured product of the optical element of Example 9 had a coefficient of hygroscopic expansion of 0.17%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 9 had a refractive index nd of 1.53 at the d-line and an Abbe number νd of 54. The birefringence was −0.00009, which was sufficiently small. The internal transmittance at a thickness of 500 μm and a wavelength of 400 nm was 98.2%, which was good.

The cured product of the optical element of Example 9 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 9.

### Example 10

Example 10 was different from Example 9 in the polymerization conditions for the polymer serving as the first material. The polymerization conditions were 65° C. for 6 hours. The weight-average molecular weight of the polymer was 73,400. Table 1 summarizes the characteristics of the resin composition 2a of Example 10. The optical element of Example 10 was manufactured in the same manner as in Example 9, except for the above.

The cured product of the optical element of Example 10 had a coefficient of hygroscopic expansion of 0.20%, and no peeling was observed. Thus, the optical element was rated B. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 10 had a refractive index nd of 1.53 at the d-line and an Abbe number νd of 54. The birefringence was −0.00007, which was sufficiently small. The internal transmittance at a thickness of 500 μm and a wavelength of 400 nm was 98.0%, which was good.

The cured product of the optical element of Example 10 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 10.

### Example 11

Example 11 was different from Example 9 in the polymerization conditions for the polymer serving as the first material. The polymerization conditions were 70° C. for 6 hours. The weight-average molecular weight of the polymer was 35,000. Table 1 summarizes the characteristics of the resin composition 2a of Example 11. The optical element of Example 11 was manufactured in the same manner as in Example 9, except for the above.

The cured product of the optical element of Example 11 had a coefficient of hygroscopic expansion of 0.21%, and no peeling was observed. Thus, the optical element was rated B. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 11 had a refractive index nd of 1.53 at the d-line and an Abbe number νd of 54. The birefringence was −0.00009, which was sufficiently small. The internal transmittance at a thickness of 500 μm and a wavelength of 400 nm was 97.8%, which was good.

The cured product of the optical element of Example 11 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 11.

### Example 12

Example 12 was different from Example 2 in the composition ratio of the resin composition. Table 1 summarizes the characteristics of the resin composition 2a of Example 12. The weight-average molecular weight of the polymer was 219,000. The optical element of Example 12 was manufactured in the same manner as in Example 2, except for the above.

The cured product of the optical element of Example 12 had a coefficient of hygroscopic expansion of 0.19%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 12 had a refractive index nd of 1.53 at the d-line and an Abbe number νd of 54. The birefringence was −0.00007, which was sufficiently small. The internal transmittance at a thickness of 500 μm and a wavelength of 400 nm was 98.0%, which was good.

The cured product of the optical element of Example 12 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 12.

### Example 13

Example 13 was different from Example 4 in the composition ratio of the resin composition. Table 1 summarizes the characteristics of the resin composition 2a of Example 13. The optical element of Example 13 was manufactured in the same manner as in Example 4, except for the above.

The cured product of the optical element of Example 13 had a coefficient of hygroscopic expansion of 0.23%, and no peeling was observed. Thus, the optical element was rated B. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 13 had a refractive index nd of 1.52 at the d-line and an Abbe number νd of 54. The birefringence was −0.00012, which was sufficiently small. The internal transmittance at a thickness of 500 μm and a wavelength of 400 nm was 97.0%, which was good.

The cured product of the optical element of Example 13 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 13.

### Example 14

Example 14 was different from Example 2 in the composition ratio of the resin composition. Table 1 summarizes the characteristics of the resin composition 2a of Example 14. The weight-average molecular weight of the polymer was 219,000. The optical element of Example 14 was manufactured in the same manner as in Example 2, except for the above.

The cured product of the optical element of Example 14 had a coefficient of hygroscopic expansion of 0.19%, and no peeling was observed. Thus, the optical element was rated A. In the adhesion test, the load was 170 N or more when mold release occurred, and peeling at the glass interface was not observed. Thus, the optical element was rated B. In the toughness test, the breaking energy was 1.0 MJ/m³ or more and less than 5.0 MJ/m³. Thus, the optical element was rated B. The cured product 2 of Example 14 had a refractive index nd of 1.53 at the d-line and an Abbe number νd of 54. The birefringence was −0.00008, which was sufficiently small. The internal transmittance at a thickness of 500 μm and a wavelength of 400 nm was 98.0%, which was good.

The cured product of the optical element of Example 14 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 14.

### Example 15

Example 15 was different from Example 14 in the composition ratio of the resin composition. This example was different from Example 14 in that 1,4-butanediol bis(thioglycolate) (E-1: difunctional, available from Tokyo Chemical Industry Co., Ltd.) was provided as a sulfur-containing compound having at least one thiol group. The optical element of Example 15 was manufactured in the same manner as in Example 14, except for the above.

The cured product of the optical element of Example 15 had a coefficient of hygroscopic expansion of 0.19%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 5.0 MJ/m³ or more. Thus, the optical element was rated A. The cured product 2 of Example 15 had a refractive index nd of 1.52 at the d-line and an Abbe number νd of 55. The birefringence was −0.00010, which was sufficiently small. The internal transmittance at a thickness of 500 μm and a wavelength of 400 nm was 99.0%, which was good.

The cured product of the optical element of Example 15 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 15.

### Example 16

Example 16 was different from Example 15 in the composition of the resin composition. This example was different from Example 15 in that trimethylolpropane tris(3-mercaptopropionate) (E-2: trifunctional, available from Tokyo Chemical Industry Co., Ltd.) was provided as the sulfur-containing compound having at least one thiol group. The optical element of Example 16 was manufactured in the same manner as in Example 15, except for the above.

The cured product of the optical element of Example 16 had a coefficient of hygroscopic expansion of 0.25%, and no peeling was observed. Thus, the optical element was rated B. In the adhesion test, the load was 250 N or more when mold release occurred, and peeling at the glass interface was not observed. Thus, the optical element was rated A. In the toughness test, the breaking energy was 5.0 MJ/m³ or more. Thus, the optical element was rated A. The cured product 2 of Example 16 had a refractive index nd of 1.51 at the d-line and an Abbe number νd of 55. The birefringence was −0.00016, which was sufficiently small. The internal transmittance at a thickness of 500 μm and a wavelength of 400 nm was 98.4%, which was good.

The cured product of the optical element of Example 16 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 16.

### Example 17

Example 17 was different from Example 3 in the composition of the resin composition. This example was different from Example 3 in that lauryl methacrylate (C-1: monofunctional, Light Ester Methacrylate L, available from Kyoeisha Chemical Co., Ltd.) was provided as a monomer containing a polymerizable functional group of a (meth)acrylate having no alicyclic skeleton. The optical element of Example 17 was manufactured in the same manner as in Example 3, except for the above.

The cured product of the optical element of Example 17 had a coefficient of hygroscopic expansion of 0.19%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 17 had a refractive index nd of 1.52 at the d-line and an Abbe number νd of 54. The birefringence was −0.00012, which was sufficiently small. The internal transmittance at a thickness of 500 μm and a wavelength of 400 nm was 97.0%, which was good.

The cured product of the optical element of Example 17 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 17.

### Example 18

Example 18 was different from Example 2 in the composition of the resin composition. Specifically, this example was different from Example 2 in that dicyclopentenyloxyethyl methacrylate (B-2: monofunctional, FA-512M, available from Showa Denko Materials Co., Ltd.) was provided as the second monomer. Table 1 summarizes the characteristics of the resin composition 2a of Example 18. The optical element of Example 18 was manufactured in the same manner as in Example 2, except for the above.

The cured product of the optical element of Example 18 had a coefficient of hygroscopic expansion of 0.19%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 18 had a refractive index nd of 1.52 at the d-line and an Abbe number νd of 54. The birefringence was −0.00008, which was sufficiently small. The internal transmittance at a thickness of 500 μm and a wavelength of 400 nm was 98.0%, which was good.

The cured product of the optical element of Example 18 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 18.

### Example 19

Example 19 was different from Example 18 in the composition of the resin composition. This example was different from Example 18 in that dicyclopentenyloxyethyl methacrylate (A-2: monofunctional, FA-512M, available from Showa Denko Materials Co., Ltd.) was provided as the first monomer. The weight-average molecular weight of the polymer was 139,000. Table 1 summarizes the characteristics of the resin composition 2a of Example 19. The optical element of Example 19 was manufactured in the same manner as in Example 18, except for the above.

The cured product of the optical element of Example 19 had a coefficient of hygroscopic expansion of 0.17%, and no peeling was observed. Thus, the optical element was rated A. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 19 had a refractive index nd of 1.53 at the d-line and an Abbe number νd of 52. The birefringence was −0.00011, which was sufficiently small. The internal transmittance at a thickness of 500 μm and a wavelength of 400 nm was 99.2%, which was good.

The cured product of the optical element of Example 19 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 19.

### Example 20

Example 20 was different from Example 18 in the composition ratio of the resin composition. Table 1 summarizes the characteristics of the resin composition 2a of Example 20. The optical element of Example 20 was manufactured in the same manner as in Example 18, except for the above.

The cured product of the optical element of Example 20 had a coefficient of hygroscopic expansion of 0.20%, and no peeling was observed. Thus, the optical element was rated B. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 20 had a refractive index nd of 1.53 at the d-line and an Abbe number νd of 53. The birefringence was −0.00007, which was sufficiently small. The internal transmittance at a thickness of 500 μm and a wavelength of 400 nm was 98.0%, which was good.

The cured product of the optical element of Example 20 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 20.

### Example 21

Example 21 was different from Example 18 in the composition ratio of the resin composition. Table 1 summarizes the characteristics of the resin composition 2a of Example 21. The optical element of Example 21 was manufactured in the same manner as in Example 18, except for the above.

The cured product of the optical element of Example 21 had a coefficient of hygroscopic expansion of 0.23%, and no peeling was observed. Thus, the optical element was rated B. In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Example 21 had a refractive index nd of 1.53 at the d-line and an Abbe number νd of 54. The birefringence was −0.00010, which was sufficiently small. The internal transmittance at a thickness of 500 μm and a wavelength of 400 nm was 97.1%, which was good.

The cured product of the optical element of Example 21 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 21.

### Example 22

Example 22 was different from Example 21 in the composition ratio of the resin composition. This example was different from Example 21 in that 1,4-butanediol bis(thioglycolate) (E-1: difunctional, available from Tokyo Chemical Industry Co., Ltd.) was provided as a sulfur-containing compound having at least one thiol group. The optical element of Example 22 was manufactured in the same manner as in Example 21, except for the above.

The cured product of the optical element of Example 22 had a coefficient of hygroscopic expansion of 0.25%, and no peeling was observed. Thus, the optical element was rated B. In the adhesion test, the load was 250 N or more when mold release occurred, and peeling at the glass interface was not observed. Thus, the optical element was rated A. In the toughness test, the breaking energy was 5.0 MJ/m³ or more. Thus, the optical element was rated A. The cured product 2 of Example 22 had a refractive index nd of 1.52 at the d-line and an Abbe number νd of 54. The birefringence was −0.00016, which was sufficiently small. The internal transmittance at a thickness of 500 μm and a wavelength of 400 nm was 98.0%, which was good.

The cured product of the optical element of Example 22 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product 2 of Example 22.

### Comparative Example 1

Comparative example 1 was different from Example 4 in the composition ratio of the resin composition. Table 1 summarizes the characteristics of the resin composition of Comparative example 1. The optical element of Comparative example 1 was manufactured in the same manner as in Example 4, except for the above.

The cured product of the optical element of Comparative example 1 had a coefficient of hygroscopic expansion of 0.33%. Thus, the optical element was rated C.

In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Comparative example 1 had a refractive index nd of 1.52 at the d-line and an Abbe number νd of 54. The birefringence was −0.00040, which was large. The internal transmittance at a thickness of 500 μm and a wavelength of 400 nm was 96.6%, which was low.

The cured product of the optical element of Comparative example 1 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product of Comparative example 1.

### Comparative Example 2

Comparative example 2 was different from Example 4 in the composition ratio of the resin composition. Table 1 summarizes the characteristics of the resin composition of Comparative example 2. The optical element of Comparative example 2 was manufactured in the same manner as in Example 4, except for the above.

The cured product of the optical element of Comparative example 2 had a coefficient of hygroscopic expansion of 0.30%. Thus, the optical element was rated C.

In the adhesion test, the load was 250 N or more when mold release occurred, and peeling at the glass interface was not observed. Thus, the optical element was rated A. In the toughness test, the breaking energy was 1.0 MJ/m³ or more and less than 5.0 MJ/m³. Thus, the optical element was rated B. The cured product 2 of Comparative example 2 had a refractive index nd of 1.52 at the d-line and an Abbe number νd of 55. The birefringence was −0.0033, which was large. The internal transmittance at a thickness of 500 μm and a wavelength of 400 nm was 96.5%, which was low.

The cured product of the optical element of Comparative example 2 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product of Comparative example 2.

### Comparative Example 3

Comparative example 3 was different from Example 2 in the composition ratio of the resin composition. Specifically, this example was different from Example 2 in that the polymer obtained by polymerizing the first monomer was not contained. Table 1 summarizes the characteristics of the resin composition 2a of Comparative example 3. The optical element of Comparative example 3 was manufactured in the same manner as in Example 2, except for the above.

The cured product of the optical element of Comparative example 3 had a coefficient of hygroscopic expansion of 0.21%, and no peeling was observed. Thus, the optical element was rated B. In the adhesion test, the load was less than 150 N when mold release occurred. Thus, the optical element was rated C. In the toughness test, the breaking energy was less than 1.0 MJ/m³. Thus, the optical element was rated C. The cured product 2 of Comparative example 3 had a refractive index nd of 1.53 at the d-line and an Abbe number νd of 54. The birefringence was −0.00009. The internal transmittance at a thickness of 500 μm and a wavelength of 400 nm was 97.9%, which was good.

The cured product of the optical element of Comparative example 3 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product of Comparative example 3.

### Comparative Example 4

Comparative example 4 was different from Example 2 in the composition of the resin composition. Specifically, this comparative example was different from Example 2 in that the polymer obtained by polymerizing the first monomer was not contained and that 1-dodecanethiol (E-3: monofunctional, available from Tokyo Chemical Industry Co., Ltd.) was provided as the sulfur-containing compound having at least one thiol group. Table 1 summarizes the characteristics of the resin composition 2a of Comparative example 4. The optical element of Comparative example 4 was manufactured in the same manner as in Example 2, except for the above.

The cured product of the optical element of Comparative example 4 had a coefficient of hygroscopic expansion of 0.20%, and no peeling was observed. Thus, the optical element was rated B. In the adhesion test, the load was less than 150 N when mold release occurred. Thus, the optical element was rated C. In the toughness test, the breaking energy was less than 1.0 MJ/m³. Thus, the optical element was rated C. The cured product 2 of Comparative example 4 had a refractive index nd of 1.52 at the d-line and an Abbe number νd of 54. The birefringence was −0.00011. The internal transmittance at a thickness of 500 μm and a wavelength of 400 nm was 98.3%, which was good.

The cured product of the optical element of Comparative example 4 had a shape with the minimum thickness at the central portion and the maximum thickness at the peripheral portion. The minimum thickness d1 was 50 μm, the maximum thickness d2 was 400 μm, and d2/d1 was 8.0. Table 2 summarizes the characteristics of the cured product of Comparative example 4.

TABLE 1

| | | | | | | | | | | | | | Total of | | | Proportion |
|---|---|---|---|---|---|---|---|---|---|---|---|---|---|---|---|---|
| | | | | | | | | | | | | | polymer, | | | of second |
| | | | | | | | | | | | Sulfur- | | second | Proportion | | monomer |
| | | | | | | | | | | | containing | | monomer, | of first | Average | and third |
| | Polymer | | Second monomer | | Third monomer | | No alicyclic | | initiator | | compound | | and third | monomer | molecular | monomer |
| | First | Content | | Content | | Content | | Content | | Content | | Content | monomer | in polymer | weight of | contained |
| Unit | monomer | % by mass | Type | % by mass | Type | % by mass | Type | % by mass | Type | % by mass | Type | % by mass | % by mass | % by mass | polymer | % by mass |
| Example 1 | A-1 | 11.8 | B-1 | 27.4 | B-4 | 58.8 | | | D-1 | 2 | | | 98 | 99.0 | 173,000 | 86.2 |
| Example 2 | A-1 | 11.8 | B-1 | 27.4 | B-3 | 58.8 | | | D-1 | 2 | | | 98 | 99.0 | 173,000 | 86.2 |
| Example 3 | A-1 | 11.8 | B-1 | 27.4 | B-3 | 39.2 | C-2 | 19.6 | D-1 | 2 | | | 78.4 | 99.0 | 216,000 | 66.6 |
| Example 4 | A-1 | 11.8 | B-1 | 27.4 | B-3 | 39.2 | C-3 | 19.6 | D-1 | 2 | | | 78.4 | 99.0 | 216,000 | 66.6 |
| Example 5 | A-1 | 11.8 | B-1 | 27.4 | B-3 | 33.2 | C-3 | 19.6 | D-1 | 2 | E-1 | 6 | 72.4 | 99.0 | 216,000 | 60.6 |
| Example 6 | A-1 | 11.8 | B-1 | 27.4 | B-3 | 33.2 | C-3 | 19.6 | D-1 | 2 | E-2 | 6 | 72.4 | 99.0 | 216,000 | 60.6 |
| Example 7 | A-1 | 11.8 | B-1 | 27.4 | B-3 | 33.2 | C-3 | 19.6 | D-1 | 2 | E-3 | 6 | 72.4 | 99.0 | 216,000 | 60.6 |
| Example 8 | A-1 | 7.3 | B-1 | 17.2 | B-3 | 73.5 | | | D-1 | 2 | | | 98 | 99.0 | 216,000 | 90.7 |
| Example 9 | A-1 | 13.2 | B-1 | 11.3 | B-3 | 73.5 | | | D-1 | 2 | | | 98 | 99.0 | 219,000 | 84.8 |
| Example 10 | A-1 | 13.2 | B-1 | 11.3 | B-3 | 73.5 | | | D-1 | 2 | | | 98 | 99.0 | 73,400 | 84.8 |
| Example 11 | A-1 | 13.2 | B-1 | 11.3 | B-3 | 73.5 | | | D-1 | 2 | | | 98 | 99.0 | 35,000 | 84.8 |
| Example 12 | A-1 | 5 | B-1 | 19.5 | B-3 | 73.5 | | | D-1 | 2 | | | 98 | 99.0 | 219,000 | 93 |
| Example 13 | A-1 | 11.8 | B-1 | 27.4 | B-3 | 30.8 | C-3 | 28 | D-1 | 2 | | | 70 | 99.0 | 216,000 | 58.2 |
| Example 14 | A-1 | 4 | B-1 | 20.5 | B-3 | 73.5 | | | D-1 | 2 | | | 98 | 99.0 | 219,000 | 94 |
| Example 15 | A-1 | 4 | B-1 | 20.5 | B-3 | 71.5 | | | D-1 | 2 | E-1 | 2 | 96 | 99.0 | 219,000 | 92 |
| Example 16 | A-1 | 4 | B-1 | 20.5 | B-3 | 58.5 | | | D-1 | 2 | E-2 | 15 | 83 | 99.0 | 219,000 | 79 |
| Example 17 | A-1 | 9.8 | B-1 | 7.35 | B-3 | 73.5 | C-1 | 7.35 | D-1 | 2 | | | 90.65 | 99.0 | 219,000 | 80.85 |
| Example 18 | A-1 | 9.8 | B-2 | 14.7 | B-3 | 73.5 | | | D-1 | 2 | | | 98 | 99.0 | 173,000 | 88.2 |
| Example 19 | A-2 | 20.6 | B-2 | 48 | B-3 | 29.4 | | | D-1 | 2 | | | 98 | 99.0 | 139,000 | 77.4 |
| Example 20 | A-2 | 21.1 | B-2 | 32.8 | B-3 | 44.1 | | | D-1 | 2 | | | 98 | 99.0 | 139,000 | 76.9 |
| Example 21 | A-2 | 14.7 | B-2 | 9.8 | B-3 | 73.5 | | | D-1 | 2 | | | 98 | 99.0 | 139,000 | 83.3 |
| Example 22 | A-2 | 14.7 | B-2 | 9.8 | B-3 | 63.5 | | | D-1 | 2 | E-1 | 10 | 88 | 99.0 | 139,000 | 73.3 |
| Comparative | A-1 | 11.8 | B-1 | 27.5 | B-3 | 18.8 | C-3 | 40 | D-1 | 2 | | | 58.1 | 99.0 | 216,000 | 46.3 |
| example 1 | | | | | | | | | | | | | | | | |
| Comparative | A-1 | 11.8 | B-1 | 27.4 | B-3 | 29.2 | C-3 | 29.6 | D-1 | 2 | | | 68.4 | 99.0 | 216,000 | 56.6 |
| example 2 | | | | | | | | | | | | | | | | |
| Comparative | no | | B-1 | 24.5 | B-3 | 73.5 | | | D-1 | 2 | | | 98 | | | 98 |
| example 3 | | | | | | | | | | | | | | | | |
| Comparative | no | | B-1 | 20.5 | B-3 | 71.5 | | | D-1 | 2 | E-3 | 6 | 92 | | | 92 |
| example 4 | | | | | | | | | | | | | | | | |

TABLE 2

| | | | | | | | | | | | | | | Proportion of | Proportion |
|---|---|---|---|---|---|---|---|---|---|---|---|---|---|---|---|
| | | | | | | | | | | | | | | difunctional | of first |
| | | | | | | | | Minimum | Maximum | | | Average | Proportion | (meth)acrylate | monomer |
| | | | | | Abbe | | | thickness | thickness | | (Meth)acrylate | molecular | of polymer | compound | contained |
| | Water | | | Refractive | number | | Transmittance | d1 | d2 | | compound | weight of | contained | contained | in polymer |
| Unit | absorption | Adhesion | Toughness | index nd | vd | Birefringence | % | μm | μm | d2/d1 | content | polymer | % by mass | % by mass | % by mass |
| Example 1 | A | A | B | 1.53 | 54 | −0.00010 | 97.6 | 50 | 400 | 8.0 | 98.0 | 173,000 | 11.8 | 58.8 | 99.0 |
| Example 2 | A | A | B | 1.53 | 54 | −0.00008 | 98.1 | 30 | 380 | 12.7 | 98.0 | 173,000 | 11.8 | 58.8 | 99.0 |
| Example 3 | A | A | B | 1.52 | 55 | −0.00012 | 97.7 | 50 | 400 | 8.0 | 78.4 | 216,000 | 11.8 | 39.2 | 99.0 |
| Example 4 | A | A | B | 1.52 | 54 | −0.00009 | 97.4 | 50 | 400 | 8.0 | 78.4 | 216,000 | 11.8 | 39.2 | 99.0 |
| Example 5 | A | A | A | 1.52 | 54 | −0.00013 | 98.5 | 50 | 400 | 8.0 | 72.4 | 216,000 | 11.8 | 33.2 | 99.0 |
| Example 6 | B | A | A | 1.52 | 55 | −0.00015 | 97.9 | 50 | 400 | 8.0 | 72.4 | 216,000 | 11.8 | 33.2 | 99.0 |
| Example 7 | A | A | B | 1.52 | 55 | −0.00010 | 97.6 | 50 | 400 | 8.0 | 72.4 | 216,000 | 11.8 | 33.2 | 99.0 |
| Example 8 | A | A | B | 1.53 | 54 | −0.00005 | 97.8 | 50 | 400 | 8.0 | 98.0 | 216,000 | 7.3 | 73.5 | 99.0 |
| Example 9 | A | A | B | 1.53 | 54 | −0.00009 | 98.2 | 50 | 400 | 8.0 | 98.0 | 219,000 | 13.2 | 73.5 | 99.0 |
| Example 10 | B | A | B | 1.53 | 54 | −0.00007 | 98.0 | 50 | 400 | 8.0 | 98.0 | 73,400 | 13.2 | 73.5 | 99.0 |
| Example 11 | B | A | B | 1.53 | 54 | −0.00009 | 97.8 | 50 | 400 | 8.0 | 98.0 | 35,000 | 13.2 | 73.5 | 99.0 |
| Example 12 | A | A | B | 1.53 | 54 | −0.00007 | 98.0 | 50 | 400 | 8.0 | 98.0 | 219,000 | 5 | 73.5 | 99.0 |
| Example 13 | B | A | B | 1.52 | 54 | −0.00012 | 97.0 | 50 | 400 | 8.0 | 70.0 | 216,000 | 11.8 | 30.8 | 99.0 |
| Example 14 | A | B | B | 1.53 | 54 | −0.00008 | 98.0 | 50 | 400 | 8.0 | 98.0 | 219,000 | 4 | 73.5 | 99.0 |
| Example 15 | A | A | A | 1.52 | 55 | −0.00010 | 99.0 | 50 | 400 | 8.0 | 96.0 | 219,000 | 4 | 71.5 | 99.0 |
| Example 16 | B | A | A | 1.51 | 55 | −0.00016 | 98.4 | 50 | 400 | 8.0 | 83.0 | 219,000 | 4 | 58.5 | 99.0 |
| Example 17 | A | A | B | 1.52 | 54 | −0.00012 | 97.0 | 50 | 400 | 8.0 | 90.7 | 219,000 | 9.8 | 73.5 | 99.0 |
| Example 18 | A | A | B | 1.52 | 54 | −0.00008 | 98.0 | 50 | 400 | 8.0 | 98.0 | 173,000 | 9.8 | 73.5 | 99.0 |
| Example 19 | A | A | B | 1.53 | 52 | −0.00011 | 99.2 | 50 | 400 | 8.0 | 98.0 | 139,000 | 20.6 | 29.4 | 99.0 |
| Example 20 | B | A | B | 1.53 | 53 | −0.00007 | 98.0 | 50 | 400 | 8.0 | 98.0 | 139,000 | 21.1 | 44.1 | 99.0 |
| Example 21 | B | A | B | 1.53 | 54 | −0.00010 | 97.1 | 50 | 400 | 8.0 | 98.0 | 139,000 | 14.7 | 73.5 | 99.0 |
| Example 22 | B | A | A | 1.52 | 54 | −0.00016 | 98.0 | 50 | 400 | 8.0 | 88.0 | 139,000 | 14.7 | 63.5 | 99.0 |
| Comparative | C | A | B | 1.52 | 54 | −0.00040 | 96.6 | 50 | 400 | 8.0 | 58.1 | 216,000 | 11.8 | 18.8 | 99.0 |
| example 1 | | | | | | | | | | | | | | | |
| Comparative | C | A | B | 1.52 | 55 | −0.00033 | 96.5 | 50 | 400 | 8.0 | 68.4 | 216,000 | 11.8 | 29.6 | 99.0 |
| example 2 | | | | | | | | | | | | | | | |
| Comparative | B | C | C | 1.53 | 54 | −0.00009 | 97.9 | 50 | 400 | 8.0 | 98.0 | | 0 | 73.5 | 0.0 |
| example 3 | | | | | | | | | | | | | | | |
| Comparative | B | B | C | 1.52 | 54 | −0.00011 | 98.3 | 50 | 400 | 8.0 | 98.0 | | 0 | 71.5 | 0.0 |
| example 4 | | | | | | | | | | | | | | | |

The types of the first monomer, the second monomer, the third monomer, the monomer having no alicyclic skeleton, the initiator, and the sulfur-containing compound in Table 1 are as described below.

### First Monomer

A-1: Dicyclopentanyl methacrylate (monofunctional, FA-513M, available from Showa Denko Materials Co., Ltd.)
A-2: Dicyclopentenyloxyethyl methacrylate (monofunctional, FA-512M, available from Showa Denko Materials Co., Ltd.)

### Second Monomer

B-1: Dicyclopentanyl methacrylate (monofunctional, FA-513M, available from Showa Denko Materials Co., Ltd.)
B-2: Dicyclopentenyloxyethyl methacrylate (monofunctional, FA-512M, available from Showa Denko Materials Co., Ltd.)

### Third Monomer

B-3: Dimethylol tricyclodecane diacrylate (difunctional, A-DCP, available from Shin-Nakamura Chemical Co., Ltd.)
B-4: Dimethylol tricyclodecane dimethacrylate (difunctional, DCP, available from Shin-Nakamura Chemical Co., Ltd.)

### Monomer Having No Alicyclic Skeleton

C-1: Lauryl methacrylate (monofunctional, Light Ester Methacrylate L, available from Kyoeisha Chemical Co., Ltd.)
C-2: 1,9-Nonanediol dimethacrylate (difunctional, NOD-N, available from Shin-Nakamura Chemical Co., Ltd.)
C-3: Trimethylolpropane trimethacrylate (trifunctional, TMPT, available from Shin-Nakamura Chemical Co., Ltd.)

### Initiator

D-1: 1-Hydroxycyclohexyl phenyl ketone (photoinitiator, Omnirad 184, available from IGM Resins)

### Sulfur-Containing Compound

E-1: 1,4-Butanediol bis(thioglycolate) (difunctional, available from Tokyo Chemical Industry Co., Ltd.)
E-2: Trimethylolpropane tris(3-mercaptopropionate) (trifunctional, available from Tokyo Chemical Industry Co., Ltd.)
E-3: 1-Dodecanethiol (monofunctional, available from Tokyo Chemical Industry Co., Ltd.)

Table 2 revealed that in each of Examples 1 to 22 in which the total amount of the polymer, the second monomer, and the third monomer contained in the resin composition 2a was 70% or more by mass and 99.5% or less by mass, the coefficient of hygroscopic expansion was less than 0.30%, and good adhesion was provided. In addition, in Examples 5 to 7, 15, 16, and 22 in which the sulfur-containing compound was contained, excellent toughness was provided.

From the above, it was found that the use of the above resin composition can provide the optical element having excellent adhesion to the transparent base and a low coefficient of hygroscopic expansion.

According to the above embodiments, it is possible to provide the resin composition that exhibits excellent adhesion to the transparent base and a low coefficient of hygroscopic expansion when used for the optical element. It is also possible to provide the optical element using the resin composition.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-148287 filed Sep. 16, 2022, and No. 2023-085514 filed May 24, 2023, which are hereby incorporated by reference herein in their entirety.

What is claimed is:

1. An optical element, comprising:
a transparent base; and
a cured product disposed on the transparent base, the cured product containing a (meth)acrylate compound having an alicyclic skeleton represented by any of the following general formulae (1) to (4),
wherein an amount of the (meth)acrylate compound contained in the cured product is 70% or more by mass and 99.5% or less by mass, 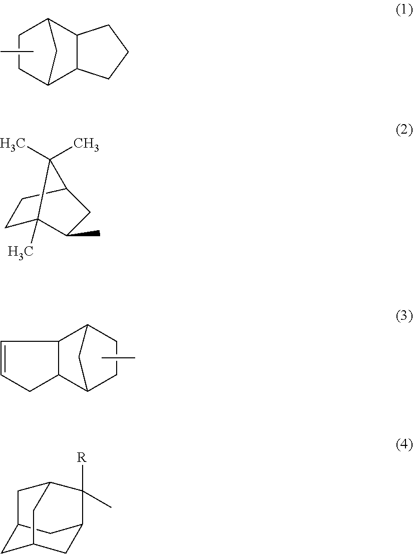
where in the general formula (4), R is a hydrogen atom, an alkyl group, or a substituted or unsubstituted alkylene group.

2. The optical element according to claim 1, wherein the (meth)acrylate compound contains a polymer obtained by polymerizing a material containing at least one first monomer of a monofunctional (meth)acrylate having an alicyclic skeleton represented by any of the general formulae (1) to (4), and
the polymer has a weight-average molecular weight of 35,000 or more and 300,000 or less.

3. The optical element according to claim 2, wherein a proportion of the polymer contained in the cured product is 5% or more by mass and 30% or less by mass.

4. The optical element according to claim 3, wherein a proportion of a portion of the polymer in which the first monomer has been polymerized is 60% or more by mass and 100% or less by mass.

5. The optical element according to claim 1, wherein the cured product contains a difunctional (meth)acrylate compound, and
a proportion of the difunctional (meth)acrylate compound contained in the cured product is 28% or more by mass and 79% or less by mass.

6. The optical element according to claim 1, wherein the cured product further contains a polymerization initiator.

7. The optical element according to claim 1, wherein the cured product has an internal transmittance of 70% or more at a wavelength of 400 nm and a converted thickness of 500 μm.

8. The optical element according to claim 1, wherein the cured product has an Abbe number of 50 or more and less than 60.

9. The optical element according to claim 1, wherein the cured product has a coefficient of hygroscopic expansion of less than 0.30%.

10. The optical element according to claim 1, wherein a difference between refractive indices nd of the cured product at a d-line in an in-plane direction and in a thickness direction is within 0.0003.

11. The optical element according to claim 1, wherein the transparent base has a first surface with a concave spherical shape, and
the cured product is disposed over the first surface.

12. The optical element according to claim 11, wherein a proportion of a maximum thickness d2 to a minimum thickness d1 of the cured product is more than 1 and 30 or less.

13. The optical element according to claim 12, wherein the minimum thickness d1 is 300 μm or less, and
the maximum thickness d2 is 10 μm or more and 1,000 μm or less.

14. The optical element according to claim 1, wherein the cured product contains a sulfur-containing compound having at least one thiol group,
an amount of the (meth)acrylate compound contained in the cured product is 70% or more by mass and 99% or less by mass, and
a proportion of the sulfur-containing compound having the at least one thiol group in the cured product is 1% or more by mass and 15% or less by mass.

15. The optical element according to claim 14, wherein the at least one thiol group of the sulfur-containing compound having the at least one thiol group comprises two thiol groups.

16. An optical apparatus, comprising:
a housing; and
an optical system including one or more lenses disposed in the housing,
wherein at least one of the lenses is the optical element according to claim 1.

17. An image pickup apparatus, comprising:
a housing;
an optical system including one or more lenses disposed in the housing; and
an image pickup element configured to receive light passing through the optical system,
wherein at least one of the lenses is the optical element according to claim 1.

18. An optical element, comprising:
a transparent base; and
a cured product of a resin composition disposed on the transparent base,
wherein the resin composition contains:
a polymer obtained by polymerizing a material containing at least one first monomer of a monofunctional (meth)acrylate having an alicyclic skeleton represented by any of the following general formulae (1) to (4), and
a second monomer containing a polymerizable functional group of a monofunctional (meth)acrylate having an alicyclic skeleton represented by any of the general formulae (1) to (4) and/or a third monomer containing a polymerizable functional group of a difunctional (meth)acrylate having an alicyclic skeleton represented by any of the general formulae (1) to (4),
wherein a total amount of the polymer, the second monomer, and the third monomer contained is 70% or more by mass and 99.5% or less by mass, 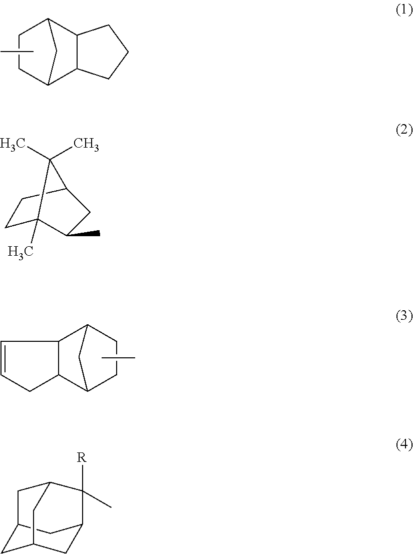
where in the general formula (4), R is a hydrogen atom, an alkyl group, or a substituted or unsubstituted alkylene group.

19. An optical apparatus, comprising:
a housing; and
an optical system including one or more lenses disposed in the housing,
wherein at least one of the lenses is the optical element according to claim 18.

20. An image pickup apparatus, comprising:
a housing;
an optical system including one or more lenses disposed in the housing; and
an image pickup element configured to receive light passing through the optical system,
wherein at least one of the lenses is the optical element according to claim 18.
